(19) United States
(12) Patent Application Publication
(10) Pub. No.: US 2021/0352181 A1
(43) Pub. Date: Nov. 11, 2021

(54) TRANSPARENCY ADJUSTMENT METHOD AND DOCUMENT CAMERA

(71) Applicant: AVER INFORMATION INC., New Taipei City (TW)

(72) Inventors: Shyh-Feng LIN, New Taipei City (TW); Wen Jui TENG, New Taipei City (TW); Cheng Yi LIN, New Taipei City (TW)

(73) Assignee: AVER INFORMATION INC., New Taipei City (TW)

(21) Appl. No.: 17/313,628

(22) Filed: May 6, 2021

(30) Foreign Application Priority Data
May 6, 2020 (TW) 109115105

(51) Int. Cl. H04N 1/00; G06K 9/00; H04N 1/40; H04N 1/028

(52) U.S. Cl. CPC H04N 1/00129; H04N 1/028; H04N 1/40; G06K 9/00375

(57) ABSTRACT

A transparency adjustment method adapted to a target object image shown in a video comprising: extracting a first frame from the video and then extracting a second frame from the video, wherein the target object image is not in the first frame and is in the second frame; selecting a target block from the second frame, wherein the target block contains the target object image; obtaining a position of the target block in the second frame and selecting a background block from the first frame according to the position; replacing the target block with the background block to generate a third frame, wherein the third frame comprises the background block and a part of the second frame other than the target block; and generating an output frame according to the third frame, a transparency parameter, and one of the second frame and the target block.

### CROSS-REFERENCE TO RELATED APPLICATIONS

This non-provisional application claims priority under 35 U.S.C. §119(a) on Patent Application No(s). 109115105 filed in Taiwan, ROC on May 6, 2020, the entire contents of which are hereby incorporated by reference.

### BACKGROUND

### 1. Technical Field

This disclosure relates to artificial intelligence, neural network, pattern recognition, and object detection, and more particularly to a transparency adjustment method adapted to a target object image shown in a video and a document camera applying this method.

### 2. Related Art

Generally, when shooting a teaching video, the body of the speaker often blocks the writing on the blackboard or the lecture content displayed on the slide, which will cause inconvenience to the learners watching the video.

So far, the image processing may perform a segmentation of human body contour, and then transparentize the human body part and the background. However, the huge amount of computation required for segmentation of human body contour consumes a lot of computation power. Therefore, it requires more hardware to support real-time video processing. If the human body contour segmentation technology is applied to the hardware platform of a general video camera, due to the limitation of hardware performance, its computing power cannot meet the requirements of real-time video processing.

### SUMMARY

According to an embodiment of the present disclosure, a transparency adjustment method adapted to a target object image shown in a video comprising: extracting a first frame from the video, wherein the target object image is not in the first frame; extracting a second frame from the video after extracting the first frame, wherein the target object image is in the second frame; selecting a target block from the second frame, wherein the target block contains the target object image; obtaining a position of the target block in the second frame and selecting a background block from the first frame according to the position; replacing the target block of the second frame with the background block of the first frame to generate a third frame, wherein the third frame comprises the background block and a part of the second frame other than the target block; and generating an output frame according to the third frame, a transparency parameter, and one of the second frame and the target block.

According to an embodiment of the present disclosure, a document camera comprising: a camera device configured to obtain a video; a processor electrically connecting to the camera device, wherein the processor is configured to extract a first frame and a second frame from the video, select a target block from the second frame, select a background block from the first frame, and generate a third frame and an output frame; and a display device electrically connecting to the processor, wherein the display device is configured to display an output video according to the output frame; wherein a target object image is not in the first frame and is in the second frame; the third frame is the second frame whose target block is replaced with the background block of the first frame; the target block contains the target object image, the target block locates at a position of the second frame, and the background block corresponds to the position of the first frame; the output frame is generated according to the third frame, a transparency parameter, and one of the second frame and the target block.

### BRIEF DESCRIPTION OF THE DRAWINGS

The present disclosure will become more fully understood from the detailed description given hereinbelow and the accompanying drawings which are given by way of illustration only and thus are not limitative of the present disclosure and wherein:

FIG. 1A is a block diagram of a document camera according to an embodiment of the present disclosure;

FIG. 1B is a schematic diagram of the appearance of a document camera 100 according to an embodiment of the present disclosure;

FIG. 2 is a flowchart of the transparency adjustment method adapted to a target object image shown in a video according to an embodiment of the present disclosure;

FIG. 3A is a schematic diagram of the first frame;

FIG. 3B is a schematic diagram of the second frame;

FIG. 3C is a schematic diagram of the background block in the first frame;

FIG. 3D is a schematic diagram of the third frame; and

FIG. 3E is a schematic diagram of the output frame.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawings.

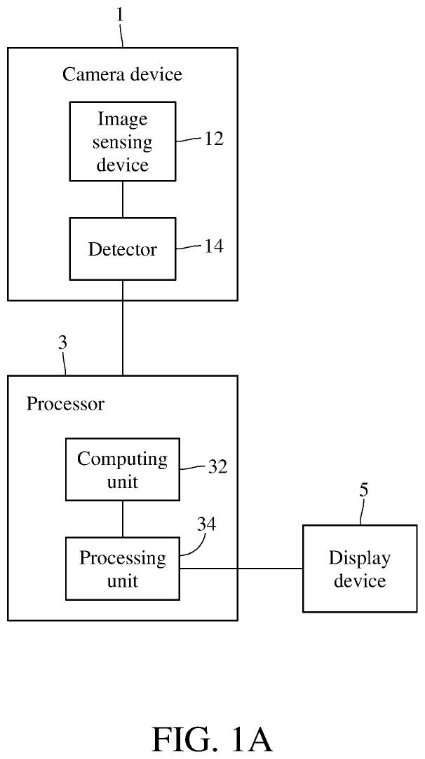

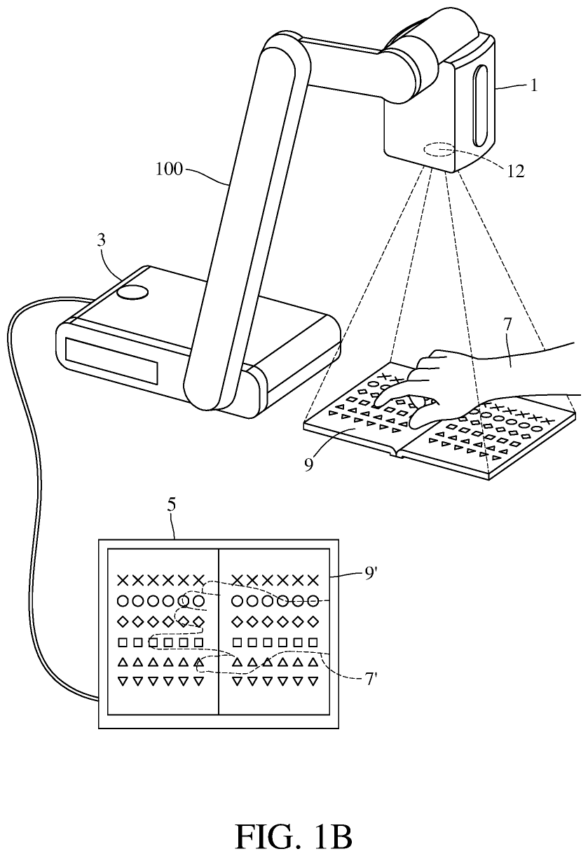

Please refer to FIG. 1A, which shows a block diagram of a document camera according to an embodiment of the present disclosure. The document camera 100 comprises a camera device 1, a processor 3, and a display device 5. The processor 3 electrically connects to the camera device 1 and the display device 5. The camera device 1 comprises an image sensing device 12 and a detector 14. The processor 3 comprises a computing unit 32 and a processing unit 34. In other embodiments of the present disclosure, the position of the processor 3 may be outside or inside the camera device 1, the display device 5 may be an external device, and the document camera 100 does not include this display device. 5. For example, in another embodiment of the present disclosure, the document camera 100 comprises the camera device 1, the processor 3, and the document camera 100 is configured to electrically connect to a display device 5. In further another embodiment of the present disclosure, the document camera 100 comprises the camera device 1 and the display device 5, wherein the camera device 1 comprises the processor 3.

Please refer to FIG. 1B, which shows a schematic diagram of the appearance of a document camera 100 according to an embodiment of the present disclosure. The document camera 100 may shoot a video by the image sensing device 12 of the camera device 1. The display device 5 shows an image of the video which includes a target object image 7′ and a background object image 9′. As shown in FIG. 1B, the target object 7 is the speaker's hand, and the background object 9 is the textbook on the desk. The speaker points a position on the textbook with his finger. The target object image 7′ is illustrated with a dashed line to represent that it is transparent in the image displayed by the display device 5. The following describes how to transparentize the target object image 7′.

Please refer to FIG. 1A and FIG. 1B together. The camera device 1 is configured to obtain a video. In other words, the camera device 1 shoot the video through the image sensing device 12 and the detector 14, wherein the video captures the target object 7 and the background object 9. In an embodiment, the computing unit 32 is configured to determine whether there is a target object 7 in the shooting direction of the image sensing device 12 and the detector 14. In other words, when the target object 7 is in the shooting direction, the detector 14 generates a trigger signal, and the processor 3 performs an algorithm to detect the target object 7 after receiving the trigger signal.

The processor 3 electrically connects to the camera device 1. The processor 3 is configured to extract a first frame and a second frame from the video, select a target block from the second frame, select the background block from the first frame, and generate a third frame and an output frame. The processor 3 is, for example, a System on Chip (SoC), a Field Programmable Gate Array (FPGA), a Digital Processor Unit (DPU), a Central Processing Unit (CPU), and a control chip, or a combination thereof. However, the present disclosure does not limit thereto. In an embodiment, the processor 3 comprises a computing unit 32 and a processing unit 34.

The computing unit 32 performs an algorithm to detect the target object image 7′. The algorithm is, for example, the Single Shot multibox Detector (SSD) or You Only Look Once (YOLO). However, the present disclosure is not limited thereof. In another embodiment of the present disclosure, the computing unit 32 is an artificial intelligence computing unit, which loads a pre-trained model to perform the algorithm. For example, images of various types of the target object 7 (such as the human hand) are collected in advance, these images are served as the input layer, and a neural network is adopted to train a model to determine whether the target object image 7′ appears in the video. Said neural network is, for example, Convolutional Neural Network (CNN), Recurrent Neural Network (RNN), Deep Neural Network (DNN), however the present disclosure is not limited thereof.

In an embodiment, the computing unit 32 determines whether the target object image 7′ is in the extracted frame. If the target object image 7′ is not in the extracted frame, this frame will be set as the first frame. If the target object image 7′ is in the extracted frame, this frame will be set as the second frame. The extraction timing of the first frame should be earlier than the extraction timing of the second frame. In addition, the computing unit 32 selects the target block from the second frame, and output the related information of the selected target block to the processing unit 34. The target block comprises the target object image 7′. In an embodiment, the computing unit 32 selects a model corresponding to a shape of the target block, wherein the shape is a rectangle or an outline of the target object 7 (such as a human hand).

The processing unit 34 electrically connects to the computing unit 32. Based on the related information of the target block outputted by the computing unit 32, such as the coordinate of the target block in the second frame, the processing unit 34 determines a position of the target block in the second frame and select the background block from the first frame according to the identical position. The processing unit 34 further generates a third frame according to the first frame and the second frame. The third frame is the second frame whose target block is replaced with the background block. In an embodiment of the present disclosure, the processing unit 34 generates an output frame according to the second frame, the third frame and a transparency parameter. In another embodiment of the present disclosure, the processing unit 34 generates an output frame according to the target block, the third frame, and the transparency parameter.

Please refer to FIG. 1A and FIG. 1B. The display device 5 electrically connects to the processor 3. The display device 5 is configured to display an output video according to the output frame. The output video has the transparent target object image 7′ and the entire background object image 9′. In practice, the output video may show a part of the background object 9 which is originally blocked by the target object 7.

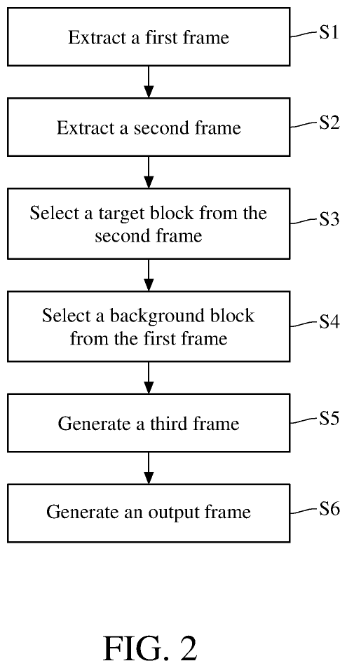

Please refer to FIG. 2, which shows a flowchart of the transparency adjustment method adapted to a target object image shown in a video according to an embodiment of the present disclosure. The method described in this embodiment is not only applicable to the document camera 100 of an embodiment of the present disclosure, but also applicable to any video teaching device or video conference device.

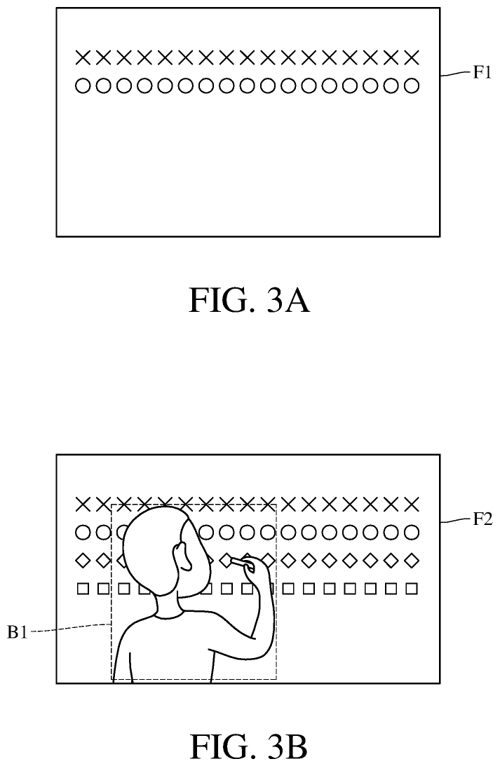

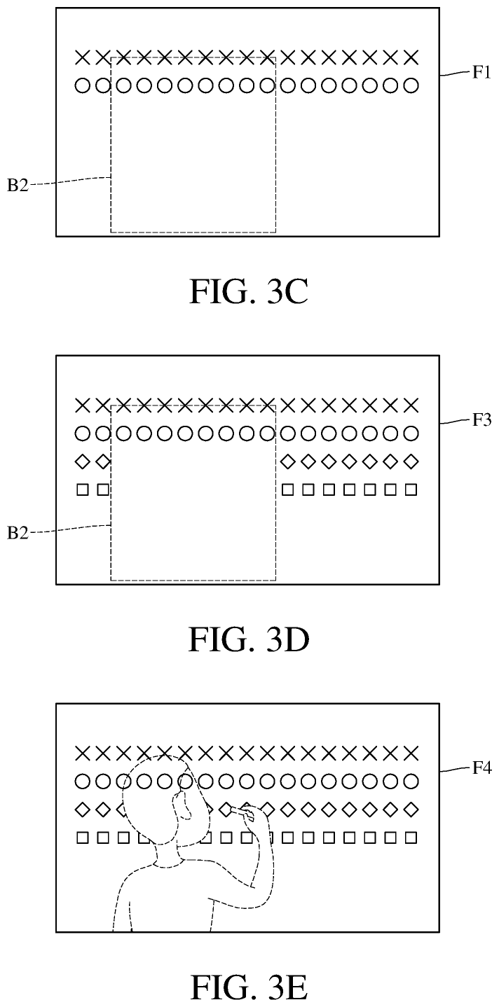

Please refer to step S1, which shows “extracting a first frame”. Please refer to FIG. 3A, which shows a schematic diagram of the first frame F1. For example, the video captured by the camera device 10 comprises two lines of text on a blackboard. The target object image 7′ does not appear in the extracted first frame. For example, the processor 3 of the document camera 100 described previously is configured to perform an algorithm to confirm whether the target object image is not in the first frame. The algorithm is Single Shot Multibox Detector (SSD) or You Only Look Once (YOLO).

Please refer to step S2, which shows “extracting a second frame”. Please refer to FIG. 3B, which shows a schematic diagram of the second frame F2. For example, the video captured by the camera device 1 comprises a speaker standing in front of a blackboard. The speaker writes two lines of text on the blackboard and blocks part of the text. The processor 3 extracts the second frame F2 from the video after extracting the first frame F1. The target object image 7′ appears in the second frame F2. In this embodiment, the target object 7 is a human. The processor 3 performs the algorithm described in step S1 to confirm whether the target object image 7′ is in the second frame F2.

Please refer to step S3, which shows “selecting a target block from the second frame”. Please refer to FIG. 3B. After performing the algorithm in step S2, the processor 3 may obtain the target block B1 having the target object image 7′. Based on the model adopted by the processor 3, the target block B1 can be a rectangle, a circle or a human body contour. However, the shape of the target is not limited by the above examples.

Please refer to step S4, which shows “selecting a background block from the first frame”. Please refer to FIG. 3C, which shows a schematic diagram regarding selecting a background block B2 from the first frame F1. The extracted background block B2 comprises two lines of text on the blackboard. Specifically, based on the position where the target block B1 locates at the second frame F2, the processor 3 selects the background block B2 corresponding to the position from the first frame F1. From another point of view, the first frame F1 and the second frame F2 have the same size, and the position of the background block B2 relative to the first frame F1 is the same as the position of the target block B1 relative to the second frame F2.

Please refer to step S5, which shows “generating a third frame”. The processor 3 replaces the target block B1 of the second frame F2 with the background block B2 of the first frame F1. Please refer to FIG. 3D, which shows a schematic diagram of the third frame F3. As shown in FIG. 3D, in the background block B2, the text on the blackboard are two lines, in the part outside the background block B2, the text on the blackboard are four lines.

Please refer to step S6, which shows “generating an output frame”. In an embodiment of step S6, the processor 3 generates the output frame according to the second frame F2, the third frame F3 and the transparency parameter. For example, assuming the transparency parameter is a, the output frame may be generated according to the following equation:

RGB_{F4}=RGB_{F2}×α+RGB_{F3}×(1−α), wherein RGB represents values of the three primary color (red, green, blue) of the frame. The transparency parameter is between 0 and 1, such as 0.3. Please refer to FIG. 3E, which shows a schematic diagram of the output frame F4. The target object image 7′ is illustrated with the dashed line to represent that the target object 7 has been transparent in the video, so that the text of two lines on the blackboard can be seen.

In another embodiment of step S6, the output frame F4 is generated according to the target block B 1, the third frame F3 and the transparency parameter a, the rest of the process is as the same as the foregoing description, and the description is not repeated here.

The above describes a process flow of the transparency adjustment method adapted to a target object image shown in a video according to an embodiment of the present disclosure. In practice, the processor 3 repeats the process of steps S1-S6 to continuously update the first frame F1, the second frame F2, the third frame, and the output frame F4, and thereby displaying the video with a transparent target object image 7′, so that the viewer may clearly see the text blocked by the speaker's body. Regarding the process for updating the first frame F1, for example, the processer 3 may update the first frame after the third frame F3 is generated in step S5 and before the step S1 is performed again. Specifically, the processor 3 sets the third frame F3 generated in step S5 as the first frame F1 when step S1 is performed next time. The processes for updating the second frame F2, the third frame F3 and the output frame F4 are performed according to steps S1-S6 as described previously, wherein the third frame F3 is served as a new first frame F1 in step S1.

In view of the above, the present disclosure uses the object detection and the algorithm in the artificial intelligence field to extract a first frame without the target object image and a second frame with the target object image. The present disclosure selects the background block from the first frame whose extraction timing is earlier, selects the target block from the second frame whose extrication timing is later, replaces the target block with the background block to generate a third frame without the target object image, and performs a mix operation according to the second frame, third frame, and the transparency parameter to achieve the effect of transparent target object. The transparency adjustment method adapted to a target object image shown in a video proposed by the present disclosure may make the speaker's body transparent so that the teaching material will not be blocked by the body. The present disclosure provides a great convenience in the video production of teaching and speech. The background content blocked by the speaker will be updated after the speaker moves away.

The object detection technology adopted by the present disclosure is mature in terms of stability and accuracy. Said object detection technology adopts the block detection policy. Compared with the pixel-based detection mechanism used in traditional human-shape cutting, the computing power required by the present disclosure is smaller. The present disclosure does not need to update every frame of the video so that the computing tasks can be further reduced. The preset disclosure is suitable for the current video cameras.

What is claimed is:

1. A transparency adjustment method adapted to a target object image shown in a video comprising:
extracting a first frame from the video, wherein the target object image is not in the first frame;
extracting a second frame from the video after extracting the first frame, wherein the target object image is in the second frame;
selecting a target block from the second frame, wherein the target block contains the target object image;
obtaining a position of the target block in the second frame and selecting a background block from the first frame according to the position;
replacing the target block of the second frame with the background block of the first frame to generate a third frame, wherein the third frame comprises the background block and a part of the second frame other than the target block; and
generating an output frame according to the third frame, a transparency parameter, and one of the second frame and the target block.

2. The transparency adjustment method of claim 1 further comprising:
performing an algorithm by a processor to confirm whether the target object image is not in the first frame and is in the second frame.

3. The transparency adjustment method of claim 2, wherein the algorithm is Single Shot Multibox Detector or You Only Look Once.

4. The transparency adjustment method of claim 1, wherein the target block is rectangular.

5. The transparency adjustment method of claim 1, wherein a shape of the target block forms a human body contour.

6. A document camera comprising:
a camera device configured to obtain a video;
a processor electrically connecting to the camera device, wherein the processor is configured to extract a first frame and a second frame from the video, select a target block from the second frame, select a background block from the first frame, and generate a third frame and an output frame; and
a display device electrically connecting to the processor, wherein the display device is configured to display an output video according to the output frame; wherein
a target object image is not in the first frame and is in the second frame;
the third frame is the second frame whose target block is replaced with the background block of the first frame;
the target block contains the target object image, the target block locates at a position of the second frame, and the background block corresponds to the position of the first frame;
the output frame is generated according to the third frame, a transparency parameter, and one of the second frame and the target block.

7. The document camera of claim 6, wherein the camera device comprises:
an image sensing device configured to obtain the video; and
a detector configured to detect a target object in a shooting direction and generate a trigger signal;
wherein the processor is further configured to perform an algorithm according to the trigger signal to obtain the target object image.

8. The document camera of claim 7, wherein the processor comprises:
a computing unit performing the algorithm to obtain the target object image and output the target block; and
a processing unit electrically connecting to the computing unit, wherein the processing unit is configured to confirm the position according to the target block, select the background block and generate the third frame and the output frame.

9. The document camera of claim 7, wherein the algorithm is Single Shot Multibox Detector or You Only Look Once.

10. The document camera of claim 8, wherein the computing unit selects a model according to a shape of the target block, wherein the shape of the target block is a rectangle or a shape of the target object.
